(19) United States
(12) Patent Application Publication
(10) Pub. No.: US 2007/0064859 A1
(43) Pub. Date: Mar. 22, 2007

(54) Method of improving the safety of accelerator coupled hybrid nuclear systems, and device for implementing same

(75) Inventors: Pavel Bokov, Orsay (FR); Igor Slessarev, Aix En Provence (FR); Danas Ridikas, Palaiseau (FR)

Correspondence Address: RATNERPRESTIA, P O BOX 980, VALLEY FORGE, PA, 19482-0980, US

(73) Assignee: COMMISSARIAT A L'ENERGIE ATOMIQUE, Paris (FR)

(21) Appl. No.: 10/561,937

(22) PCT Filed: Jun. 30, 2004
(86) PCT No.: PCT/FR04/50302

§ 371 Date: Jun. 20, 2006

(30) Foreign Application Priority Data
Jun. 30, 2003 (FR) 03/07920
Sep. 5, 2003 (FR) 03/10540

(51) Int. Cl. G21G 1/10

(52) U.S. Cl. 376/194

(57) ABSTRACT

The present invention pertains to a method of controlling an accelerator coupled nuclear system comprising a nuclear reactor operating in subcritical mode and a neutron generator device using a beam of charged particles originating from an accelerator, said neutron generator supplying the quantity of neutrons necessary in order to maintain the nuclear reaction. Said method is characterized in that the operating point is determined by giving the energy Eₚ of the particles a value greater than or equal to the value E_{PMax}, which maximizes the production of neutrons, and in that the number of neutrons is adjusted by acting on the energy of the particles originating from the accelerator, with constant beam intensity. The present invention also pertains to the accelerator coupled hybrid nuclear system used for same.

### TECHNICAL FIELD

The present invention pertains to a method of controlling a subcritical hybrid nuclear system having a controlled external neutron source and to a device implementing this method, in particular for improving the safety of hybrid nuclear systems, which are assigned to the production of energy and/or the transmutation of certain transuranic chemical elements present in nuclear waste (“waste incineration”).

It also pertains to a hybrid nuclear system applying this method.

### STATE OF THE ART

The control of the nuclear reaction implemented in a nuclear power plant and the limitation of the quantity of wastes produced by this reaction are two major problems of the nuclear industry, these safety and waste production problems varying depending on the system used for operating the nuclear reaction.

For this purpose, it should be recalled that these systems can be classified according to their criticality, with a system being classified as critical when the number of neutrons emitted by fission of the nuclear fuel is equal to the number of neutrons which disappear due to absorption and due to leakage. In this case, the number of fissions observed during successive time intervals continues to be constant, with the criticality being the expression of an exact balance between the productions of neutrons due to fission and the disappearances of neutrons due to absorption and due to leakage.

Conversely, a system is classified as subcritical when the number of neutrons emitted by fission is lower than the number of neutrons disappearing due to absorption and due to leakage. In this case, the number of fissions observed during successive time intervals decreases and the intensity of the nuclear reaction subsides.

The behavior of these systems is generally characterized by the multiplication factor k, which represents the average value of the number of new fissions induced by the neutrons originating from an initial fission. It can be expressed, for a given time interval, by the ratio of the number of neutrons produced by fissions to the number of neutrons which have disappeared. If this factor takes into account leakages of neutrons to the fuel assemblies close to or outside of the reactor, this is classified as effective and written as k_{eff}. For a subcritical reactor, k_{eff} is less than 1, but close to 1 (typically on the order of 0.95 to 0.995). For a critical reactor, k_{eff} is equal to 1.

Its variations around the critical value of 1 are represented by the reactivity, a dimensionless variable defined by:
ρ=(k_{eff}−1)/k_{eff}

Since its value is very small, it is generally expressed in hundred thousandths, using pcm (per hundred thousandth) as a unit. In a reactor, the reactivity is zero if it is critical, positive if it is supercritical and negative if it is subcritical.

A subcritical reactor must resort to using an external neutron source in order to maintain the nuclear reaction. The neutrons supplied by this source are classified as external neutrons. As this external neutron source is supposed to be intense, it is generally produced by nuclear reactions, and essentially spallation reactions, induced by the impact of high-energy charged particles (0.6 to 1.2 GeV), generally protons or deutrons, on a target preferably composed of heavy elements, such as, for example, lead, bismuth or uranium. However, these external neutrons must have an energy on the same order of magnitude as the neutrons maintaining the reaction of the core in order to have optimal effectiveness, which is easy to carry out with spallation neutrons; if they are too fast, they can be slowed down by techniques known to the person skilled in the art.

The spallation target is generally available in the form of a lead-bismuth liquid contained in a reservoir placed at the center of the core in order to optimize the probability of reaction with the combustible material. From the point of view of neutron generation, this mixture behaves like lead, but has the advantage of a greater capacity for liquefaction under the effect of the energy supplied by the beam of particles (lower liquefaction temperature) to the target. The use of a lead-bismuth target improves the thermal behavior of this target for the nominal operation of the reactor. If the dimensions of this target are sufficient, it can be estimated that a proton of 1 GeV projected onto a lead or lead-bismuth target can thus generate 20 to 25 neutrons that can be used by the reactor.

The protons can be accelerated by any means suitable for communicating to them an energy ranging from approx. a few dozen megaelectrovolts (MeV) to a few dozen gigaelectronvolts (GeV). These means generally comprise an accelerator located on the outside of the reactor, whose beam is directed up to the spallation target located in the core.

Except for spallation, any other neutron source may be suitable. Photonuclear reactions, the conversion yield of which is much less elevated than spallation reactions, may be mentioned as an example. In these two cases, the neutrons produced have a comparable energy that is adequate for the operation of a hybrid system.

The photonuclear reactions are considered here globally, i.e., composed of two successive reactions. The first one is a Bremsstrahlung reaction, in which electrons react to give rise to high-energy photons according to a linear cross section depending on the energy of the electrons. The energy spectrum of the photons produced is very broad, ranging between zero and the energy of the incident electrons. The second reaction produced is the photonuclear reaction itself, and this second reaction implies phenomena analogous to a spallation reaction.

These photonuclear reactions supply lower intensities of the neutrons produced (at present, up to about 5×10¹⁶ neutrons/sec, while spallation permits up to a few 10¹⁸ neutrons/sec). However, they imply much lower costs for the generation and the acceleration of the electrons (investment of the plant about ten times lower), and for use because of a high reliability and the less elevated level of qualification of the personnel. The plant shall be much more compact, but the consumption of energy due to neutrons produced shall be about thirty times higher.

The hybrid reactors are a priori known for their capacity to receive in their core a part of the nuclear wastes, namely long-life radioactive elements such as transuranic elements or certain fission products, in order to “incinerate” them (i.e., to transmute them into short-life stable or radioactive nuclei). However, the introduction of transuranic elements leads to a serious degradation of certain, very important properties for the safety of the nuclear reactor, and particularly a reduction in the delayed neutron fraction and a reduction in the Doppler effect.

This Doppler effect is due to the variation of the relative velocity of a neutron moving in the material in relation to the nuclei which are not immobile but subjected to a thermal agitation. These slight differences in relative velocity are generally negligible except if the cross sections vary very suddenly depending on this relative neutron/nucleus velocity, as is the case in the vicinity of the resonance peaks. The immediate effect of a local increase in the temperature of the fuel of a nuclear reactor is to enlarge the neutron-capturing, resonant cross sections of a certain energy and therefore to make the neutron flux drop locally. More neutrons are captured and thus those that are available for new fissions are less numerous.

In this case, the Doppler effect is characterized by a negative factor and contributes to making the nuclear systems intrinsically safe.

Among the effects acting on the reactivity of a reactor, the Doppler effect is the fastest and the most sensitive. It is a self-stabilizing factor essential to the regulation of the reactor because it is spontaneous and all the more powerful since the disturbance (variation in temperature) that created it is greater.

In a nuclear reactor, the great majority of the fission reactions immediately give rise to the emission of a few neutrons; however, a very small number of these neutrons (less than 1% of the neutrons emitted) are called delayed because they are emitted by fission fragments with a delay of a few seconds, on average, after the fission. These are those that, due to this gap in time, permit, in fine, the control of the reactors. This fraction of delayed neutrons is designated by β (typically on the order of 0.65% for a fuel based on uranium 235).

The value of the delayed neutron fraction β is extremely important for the safety and for the control of a nuclear reactor, because this parameter (with the average appearance time of delayed neutrons) defines the natural period of the reactor. This period must be long enough to permit the controlling of the system.

This significant degradation of the safety parameters described above (degradation of the Doppler factor and of the delayed neutron fraction) makes the transmutation of nuclear waste very problematic in the classical critical reactors. It acts very differently according to the functional type to which the system is connected, such that each has its own shortcomings and qualities.

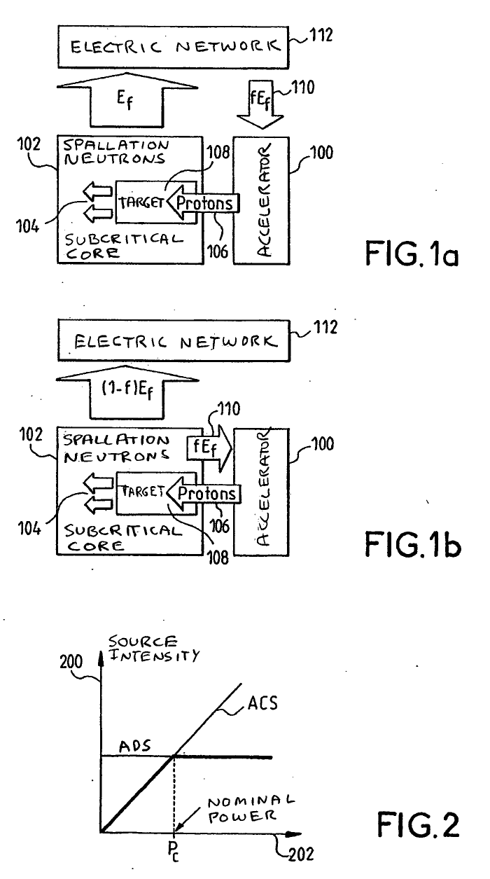

For this purpose it is recalled that the subcritical nuclear systems can be functionally divided into two types, schematically shown by means of FIGS. 1a and 1b, in which are shown a reactor 102, in subcritical mode, receiving external neutrons 104 produced by a nuclear reaction (especially from spallation) on a target 108 by means of a beam of charged particles 106 (for example, protons) originating from an accelerator 100, fed by the electrical network 110. This same network receives, moreover, the electric energy produced from the heat generated by the subcritical reactor 102.

According to a first type of system, called uncoupled, or, in English, an “Accelerator Driven System” (ADS) (FIG. 1a), the intensity of the external neutron source is independent of the power of the core and the energy needed for feeding this source is taken from an electric network as shown in FIG. 1a. In this system, it is the intensity of the external source which defines the power of the nuclear plant, and the subcritical core is only used to enhance the external neutrons and the energy deposited via the fission reaction. In such systems, the level of subcriticality is predetermined in the nominal state, for example, depending on the safety conditions that are set, on the fuel and on the desired thermal power. It can be adjusted during the operation of the reactor. The intensity of the beam of particles is predetermined depending on the operating conditions required of the reactor and then adjusted during operation by an operator.

However, taking into account their high level of subcriticality, the ADS uncoupled systems need an important neutron source. This requires the use of powerful accelerators, which is economically penalizing because such accelerators considerably increase the cost of the plant, but also its operating cost by consuming a significant fraction of the electric power produced (from a few percentage points up to 10%).

As for safety, there is no constraint either on the value of the Doppler factor or the delayed neutron fraction, if the level of subcriticality is great enough to avoid all the negative consequences linked with the possible variation in the neutron multiplication factor k_{eff} (reactivity accident). Nevertheless, there is a risk for a specific accident for the ADS uncoupled systems: The accidental insertion of the maximum current of the beam of protons, which is possible regardless of the power of the core because of the feeding of the accelerator by the network.

According to a second type of system, called coupled, or, in English, “Accelerator Coupled System” (ACS) or even “Delayed Enhanced Neutronics” (DEN) (FIG. 1b), the intensity of the external neutron source depends directly on the power of the core, and it is selected in real time so that the entire system is in a critical state. In such systems, the safety depends on the following parameters, in particular: negative feedback factors, delayed neutron fraction and subcriticality level. The reactor can no longer be controlled as in the preceding case by an action of the operator based on the correspondence between the power of the core and the intensity of the external neutron source; here, the control shall be performed by other means, for example, reactor control rods, or a modification of the fraction of the power of the core assigned to the feeding of the accelerator, or even the possible addition of a second external neutron source (optional), with much less power.

A principal difference between these two systems lies in the fact that, in accelerator coupled systems (ACS), the quantity of external neutrons produced is predetermined to maintain the chain reaction in the core, while, in an accelerator driven system (ADS), this intensity varies in real time in order to obtain the exact value of the power desired for the reactor.

In the accelerator coupled systems, the external source of neutrons, naturally or artificially delayed in relation to the rate of fission in the core, may replace a deficiency of delayed neutrons. This possibility of supplying the latter by an external source gives rise to the concept of a reactor, in which a group of delayed neutrons is artificially created (“The Neutron Potential of Nuclear Power for Long Term Radioactivity Risk Reduction,” by M. Salvatores, I. Slessarev, M. Uematsu, and A. Tchistiakov, Proc. GLOBAL-95 Int. Conf., Versailles, France, Sep. 11-14, 1995, v. 1, p. 686).

To enhance the coupling between the core and accelerator, A. Gandini, M. Salvatores and I. Slessarev suggested, in the document “Coupling of reactor power with accelerator current in ADS systems,” Accelerator Driven Transmutation Technologies and Applications Conference, Jun. 7-11, 1999, Prague, and in Annals of Nuclear Energy, 27 (13), 1147 (2000), using a fixed part f of the energy produced by the same hybrid system, the reactor in this case, for feeding the accelerator. Such an embodiment of a hybrid systems ensures the intrinsic stopping of the external neutron source in case of thermohydraulic failures; however, it does not offer protection against a possible criticality incident.

The entire nuclear system, comprising the nuclear reactor, the accelerator, the target and all of the attached means ensured their functional cooperation, thus behaves like a critical reactor, of which it has all the functional advantages, and particularly, the benefit of internal negative feedback effects known for the latter (ex.: the Doppler effect, the expansion of the nuclear fuel, etc.), whose list depends on the embodiments of the nuclear reactor in question.

Studies of hybrid systems, whose concepts are presented above, have shown that they have a different kinetics, especially during accidental situations (ex.: removal of control rod, rupture of the window of the spallation target, circulation pump failure, etc.) not protected by human intervention or by the control systems. Consequently, possible unprotected transients develop differently in the systems, which has a great impact on safety. As for the latter, each of the two hybrid systems has its advantages and its drawbacks. For example, the behavior of the accelerator coupled systems (ACS) is preferable from the point of view of thermohydraulic accidents; on the other hand, accelerator driven hybrid systems (ADS) offer better support for reactivity accidents (accidental increase in k_{eff} of the system). It proves to be advantageous, therefore, to combine the advantages of the two types of systems.

The advantages and drawbacks of these two functional types of hybrid systems are studied in the document “The accelerator coupled system dynamics” of A. D'angelo et al., Accelerator Driven Transmutation Technologies and Applications Conference, 2001, but also and especially in the document “Coupling of reactor power with accelerator current in ADS systems” of A. Gandini, M. Salvatores and I. Slessarev, Accelerator Driven Transmutation Technologies and Applications Conference, Jun. 7-11, 1999, Prague, and Annals of Nuclear Energy, 27 (13), 1147 (2000).

They are schematically shown in FIG. 2, in which the Y axis 200 represents the intensity of a source of charged particles and the X axis 202 represents the power of the core of the nuclear reactor.

For an accelerator driven system ADS, the intensity of the source is constant regardless of the power of the core. In particular, for a core power greater than the nominal power Pₙ, the intensity of the source does not increase, which limits any uncontrolled increase in the power supplied by the core.

However, such a hypothetical embodiment has a major drawback linked with a possible electronic or human error regarding the control of the particle accelerator. In this case, dangerous thermohydraulic accidents remain possible.

For accelerator coupled systems ACS(DEN) the intensity of the source varies proportionally with the power of the core. Thus, for a core power greater than the nominal power Pₙ, the increase in the core power induces a proportional increase in the intensity of the neutron source.

Such accelerator coupled systems, which have the advantages of critical systems, also have the drawbacks thereof. As regards possible unprotected reactivity accidents, the asymptotic balance values are defined by negative feedback effects. The latter being degraded (as in the case of waste transmutation), the safety also decreases.

The aim of the present invention is to produce an ACS system, whose ideal behavior in the case of an unprotected accident would be: below its nominal power, the behavior of a prior-art ACS system, and above its nominal power, the behavior of a prior-art ADS system. In any case, the goal of the present invention is to suggest a novel method of control, which intrinsically improves the safety of an accelerator coupled system.

The aim of the present invention is to provide a system combining the advantages related to safety of the accelerator coupled systems intrinsically, i.e., without requiring a manual or automated intervention.

### DISCLOSURE OF THE INVENTION

The present invention is a result of the observation that, for a known particle accelerator of a hybrid system, the intensity of the source is supposed to be proportional to the power of the reactor.

If the intensity of the neutron source is not proportional to the power of the reactor, this intensity might increase to a lesser degree than the increase in power of the reactor, such that the source might no longer support this increase in power of the core of the reactor.

On the other hand, even in the absence of such a proportionality between the power of the source and the power of the reactor, the advantage linked with the fact that the decrease in the core power would lead to the decrease in intensity of the neutron source might be retained.

Such a hybrid accelerator coupled system with nonproportional interdependence between the intensity of the external source and the power of the core would have limited asymptotic power and temperature values. This dependence relationship suggested above on the asymptotic state of the system would be equivalent to that of the Doppler effect. This is why it will be called “Doppler effect” for the accelerator part of an ACS. Nevertheless, contrary to the actual Doppler effect, such a “Doppler effect” is not altered by the presence of minor actinides.

Moreover, the present invention aims, alternatively, to prolong the cycle of the reactor and to reduce the quantity of wastes generated by a nuclear power plant.

In fact, the quantity of wastes produced by a nuclear power plant is proportional to the rate of combustion of its fuel, this rate being all the lower since the safety threshold applied with regard to an accidental transient is high.

Consequently, supplying a nuclear system having an intrinsically increased degree of safety, the present invention makes it possible to maintain, for a nuclear system, an identical degree of safety with a higher rate of combustion, potentially reducing the quantity of wastes produced by an industrial type reactor, such as, for example, those assigned to the production of electricity.

Thus, the aim of the present invention is to solve the different problems mentioned above by making possible a self-regulated and reliable operation of an accelerator coupled system even in the presence of a large quantity of actinides, which makes it possible to make a nuclear system secure intrinsically, and, consequently, to use the nuclear fuel with a greater rate of use, or even to recycle the nuclear fuel.

To obtain this result, the present invention is based not only on the selection of an operating point minimizing the energy necessary for the production of neutrons, but also basically even on the modalities of adjusting the number of neutrons produced in order to control the reactor and namely to adapt it, at any time, to a deposited power, this adjustment being performed by controlling not only the intensity of the beam of particles, but also the energy of each of its particles.

This selection of the operating point (which amounts to selecting the operating energy) aims, of course, at maximizing the energy yield of the nuclear plant by minimizing the energy-related cost of producing a neutron. In the most general embodiment of the present invention, it resembles what is established in case of spallation reactions by the document “Neutron production in bombardments of thin and thick W, Hg, Pb targets by 0.4, 0.8, 1.2, 1.8 and 2.5 GeV protons” from A. Letourneau, J. Galin, F. Goldenbaum et al. in “Nuclear Instruments and Methods in Physics Research” B 170 (2000) pp. 299-322. In particular, the paragraph 4.4 “The neutron economy” establishes that there is an optimal value Eₚ^{Max} of the accelerated particle energy (ranging from 0.8 GeV to 1 GeV for the experience mentioned), for which the number of neutrons produced by an incident proton (neutron yield Yₙ) is optimal. If the curve of the number of neutrons produced normed by the energy having been used to produce them (FIG. 16, p. 319) is traced, the existence of a peak value corresponding to the optimal particle energy Eₚ^{Max} is observed.

The existence of this maximum is linked with the fact that, at low energy, a significant fraction of the energy of the incident beam is lost due to ionization. At very high energy, a part of the energy is lost in the form of production of particles other than neutrons (essentially pions). In addition, for a target whose dimensions are fixed, the increase in the energy of the incident particles increases the probability of leakages of neutron-producing particles and, therefore, decreases the neutron yield in the target.

A second, more exhaustive document arrives at the same conclusions, putting Eₚ^{Max} between 1 GeV and 1.5 GeV within the framework of Pb targets and W plates, with a subcritical assembly of natural uranium moderated by water: “Nuclear data at high energy: experiment, theory and applications” of S. Leray, report CEA/DAPNIA/SPHN-00-67 and lecture at the “Workshop on Nuclear Reaction Data and Nuclear Reactors: physics, design and safety,” ICTP Trieste, Italy, Mar. 13/Apr. 14, 2000.

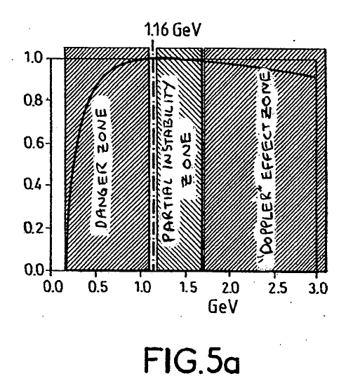

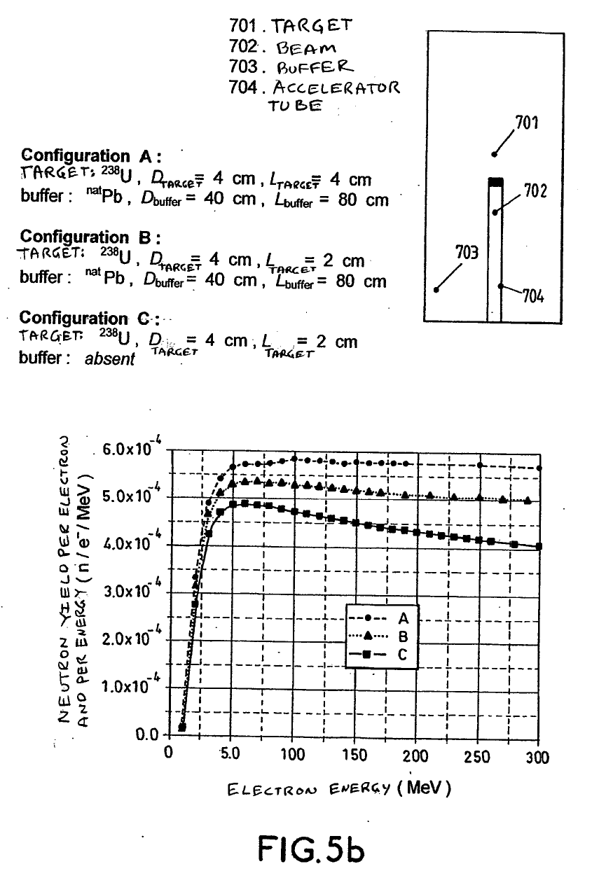

It has been seen that the photonuclear reactions are considered here globally, i.e., composed of two successive reactions. The first one is a Bremsstrahlung reaction, in which electrons react to give rise to high-energy photons according to a linear cross section depending on the energy of the electrons. The second reaction produced is the actual photonuclear reaction, this second reaction implying phenomena analogous to a spallation reaction. The set of these two successive reactions has a global curve analogous to that of a spallation, but with more or less different numerical values (especially for Eₚ^{Max}), as shown in FIGS. 5a and 5b.

Even though it is known, this property of the existence of optimal energy does not have its own name. It will be named the neutron yield effect or “Yₙ effect” or even the “Doppler” effect for the accelerator part of a hybrid system.

Therefore, there is good reason to illustrate the general case of the production of neutrons by charged particles by means of the well-known particular case of spallation induced by protons.

In reality, for the devices according to the prior art, the accelerator in an ACS is adjusted by acting on the intensity of the beam Iₚ, with constant particle energy, which has various advantages for the person skilled in the art: Since the beam acceleration and deviation structures are preset, it was possible to select operating conditions corresponding to a better energy efficiency for these pre-adjustments (parameterization).

The main point of the present invention consists, after having selecting the operating point minimizing the energy necessary for the production of neutrons, of continuously adjusting the particle accelerator not by the intensity of the beam as in the prior art, but by the energy of the particles emitted.

More globally, the supply of external neutrons varies depending on the charged incident particle energy Eₚ according to a curve in FIG. 8 of the above-mentioned S. Leray document. As the energy Eₚ increases, the number of neutrons quickly increases at first beyond the reaction threshold. Then, beyond the energy Eₚ^{Max}, this number continues to increase but less quickly. The shape of this curve corresponds to that of FIG. 8 of the Leray document. If this curve is normed by dividing the number of neutrons produced by the energy having been used to produce them, FIG. 5a is obtained, clearly showing a maximum, the shape of this curve corresponding to that of FIG. 16 of the above-mentioned A. Letourneau et al. document and FIG. 9 of the Leray document. These curves of FIG. 5a are found to have the same general shape, regardless of the reaction selected for producing the neutrons from charged particles (ex.: protons, deutons, electrons). Only the numerical values vary, especially that of the optimal particle energy Eₚ^{Max}.

For a more effective implementation of the present invention, in practice it is necessary to take into account not only the neutron yield per incident particle and per its energy Eₚ, but also the neutron importance φ* (in English: “neutron importance,” a value which describes the importance of external neutrons in relation to the neutrons of the core) and the yield of the accelerator ηa (a value which describes the relationship between the charged particle energy Eₚ and the energy E that the accelerator consumes to accelerate this particle).

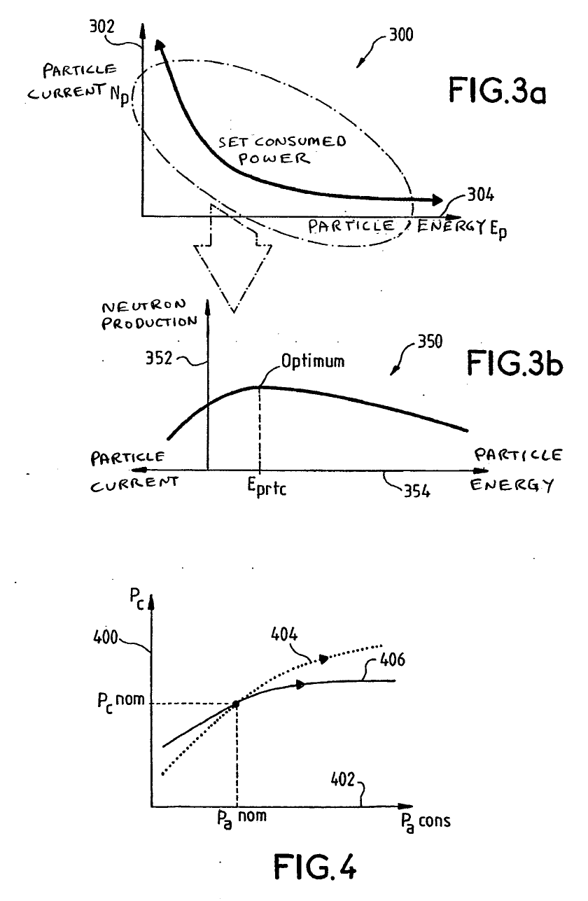

The optimal particle energy Eₚ^{Max} can be determined empirically beforehand as follows. The power consumed in the particle accelerator (P_{cons}) is kept constant, while simultaneously varying the energy of the particles and the intensity of the particle beam, as shown in FIG. 3a.

In practice, this value of the power P_{cons} shall be selected so that the power of the nuclear reactor is equal to the consigned value that was initially set. In all cases, experience demonstrates an optimal energy Eₚ^{Max} of the neutron production.

Therefore, the present invention consists of a method of controlling an accelerator coupled nuclear system (ACS) comprising a nuclear reactor operating in subcritical mode and a neutron generator device using a beam of accelerated charged particles, the neutron generator supplying the quantity of neutrons necessary in order to maintain the nuclear chain reaction in the core, and the operating point of the system being selected more or less around the optimal point at which the ratio of the number of external neutrons produced, divided by the energy of the proton beam having been used to produce them, is maximum, this method being characterized in that the number of external neutrons depending on the operating fluctuations of the power of the nuclear reaction is adjusted by acting on the energy of the charged particles Eₚ generated and accelerated by the accelerator.

Preferably, this method comprises the following steps:

1. Determine the operating conditions under which it is desired to operate the nuclear reactor: The level of subcriticality (r₀), consumable power to be produced (thermal Pₜₕ or electric Pₑₗ=ηₑₗPₜₕ where ηₑₗ is the electric yield of the plant), quantity and kind of fuel (this determination makes use of the usual know-how of the person skilled in the art). The preferred embodiment of the coupling between the subcritical core and the accelerator appears in the document of A. Gandini, M. Salvatores and I. Slessarev, i.e., a fixed fraction f of the power produced by the system is consumed for feeding the accelerator.

2. From these conditions, determine the operating parameters of the accelerator as follows:
a—Determine the optimal energy Eₚ^{Max} of the charged particles, which verifies the expression:
   d/dEₚ[φ*(Eₚ)ηₐ(Eₚ)Y(Eₚ)/Eₚ]=0. (1)

This formula takes into account the possible dependences of the incident particle energy Eₚ on the neutron yield Y, on the neutron importance φ*, on the yield of the accelerator ηₐ.
b—Select the operating energy (nominal energy)
   Eₚ^{nom} equal to or greater than the optimal energy Eₚ^{Max}:
   Eₚ^{nom}=Eₚ^{Max}+ΔEₚ, ΔEₚ≧0. (2)

The justification of the introduction of ΔEₚ and the value to be given to it shall be explained below.
c—Determine the nominal intensity of the beam of charged particles necessary to obtain the nominal power of the reactor Pₜₕ^{nom} depending on the nominal energy Eₚ^{nom}, on the neutron yield Yₙ(Eₚ^{nom}), on the yield of the accelerator ηₐ(Eₚ^{nom}) and on the neutron importance φ*(Eₚ^{nom}) for the nominal energy Eₚ^{nom}:
   Iₚ^{nom}=r₀vPₜₕ^{nom}/[E_{fis}φ*(Eₚ^{nom})Yₙ(Eₚ^{nom})], (3)
   as well as the fraction of the power produced Pₑₗ consumed by the accelerator:
   f^{nom}=Eₚ^{nom}r₀v/[E_{fis}φ*(Eₚ^{nom})Y(Eₚ^{nom})ηₐ(Eₚ^{nom})ηₑₗ. (4)

3. Set the fraction f of the power produced by the reactor that can be consumed by the accelerator, as well as the intensity of the incident particle beam at nominal values according to formulas (3) and (4).

4. Adjust the number of external neutrons acting on the particle energy Eₚ with constant beam intensity, depending on the operating power fluctuations of the nuclear reactor, according to the expression determining the variation of the energy:
Eₚ=f^{nom}Pₑₗηₐ(Eₚ)/Iₚ^{nom} (5)

The formulas and approach presented below are explained below.

The energy E that must be spent to accelerate one particle up to the energy Eₚ depends on the yield of the accelerator ηₐ: E=Eₚ/ηₐ. This yield itself may depend on the maximum energy up to which the charged particles are accelerated: ηₐ=ηₐ(Eₚ). Thus, the power consumed for the particle acceleration Iₚ per second can be expressed by:
P_{cons}=EₚIₚ/ηₐ. (6)

Taking into account that an incident particle energy Eₚ creates, on average, Yₙ neutrons, the intensity of the neutron source shall be linked with the current beam value:
Iₙ=IₚYₙ (7)

The thermal energy Eₜₕ created in a subcritical core by an external neutron and absorbed is:
Eₜₕ=E_{fis}φ*/(vr₀o) (8)
in which r₀=(1=k_{eff})/k_{eff} is the level of subcriticality; φ* is the neutron importance; E_{fis} is the energy supplied during a fission reaction; v is the average number of fission neutrons. The neutron importance depends a priori on the incident particle energy, i.e., φ*=φ*(Eₚ). However, in some systems, it is observed that it is possible to assimilate it with a constant. The thermal power of the subcritical core (if energy released in the target is not taken into account) is:
Pₜₕ=(φ*ηₐYₙ/Eₚ)P_{con}E_{fis}/(vr₀) (9)

Assuming that the power consumed P_{cons} is set, the optimal energy of the charged particles Eₚ=Eₚ^{Max} can be selected so that the power of the core is maximum. This condition means that dPₜₕ(Eₚ^{Max})/dEₚ=0, d²Pₜₕ(Eₚ^{Max})/dEₚ²<0. When this value exists, the optimal energy shall be defined by the expression (1).

In rare cases, it may be that this optimal point, visible in FIG. 5b (curve A), is less marked because of a very low slope to the highest particle energies, and possibly because of the imprecision of measurements. In these cases, this maximum, and therefore the “Yₙ effect,” can be enhanced by optimizing the geometry of the target, for example, in the sense of an increase in the losses of the incident particles in the target. Although this reduces the neutron production efficiency, this makes it possible, on the other hand, to benefit more from the “Yₙ effect.” The “Yₙ effect” can also be increased by modifying the target, either by reducing its dimensions, or by surrounding it with a possible buffer, as transparent as possible to the neutrons already created and whose neutron conversion yield is less than that of the target, or even by a combination of these two conditions. This conversion yield must be as low as possible, and preferably less than half of the conversion yield of the actual target.

In the particular case of photonuclear reactions, FIG. 5b shows, as an example, that the shapes of curves are globally the same, with three configurations corresponding to:

curve A (top): target made of uranium 238, in the form of a cylindrical pellet with an axis of symmetry joined with the axis of the particle beam, this pellet having a diameter of 4 cm and a height of 4 cm, this target being surrounded by a lead-absorbing buffer in the form of a cylinder with an axis of symmetry joined with the axis of the particle beam, this cylinder having a diameter of 40 cm and a height of 80 cm, and comprising an axial bore of 4 cm, enabling the beam to reach the actual target located at the center of this damper cylinder,

curve B (middle): target made of uranium 238, in the form of a cylindrical pellet having an axis of symmetry joined with the axis of the particle beam, this pellet having a diameter of 4 cm and a height of 2 cm, this target being surrounded by a lead-absorbing buffer identical to that of the configuration corresponding to curve A,

curve C (bottom): target made of uranium 238 according to that of the configuration corresponding to curve B, and absence of an absorbing buffer.

Nevertheless, it is remarked that curve A has an almost absence of maximum. In such cases, a maximum can be made to appear by the same target modifications as already seen for spallation reactions.

This mode of controlling by the energy of particles originating from the accelerator leads to the external neutron source not being more exactly proportional to the power of the core. A new “Doppler” negative feedback effect appears for the accelerator part of the accelerator coupled hybrid system, which stabilizes the power of the system during unprotected transients.

One advantage of the present invention can be illustrated by considering a sudden variation of power in a nuclear system, for example, in the sense of an increase in the neutrons produced.

In this case, the result is an increase in heat released in the core, and then of the electric energy that feeds the accelerator.

The ACS systems according to the prior art would respond to this with an action increasing the intensity of the proton beam, which would relatively quickly increase the number of external neutrons, according to curve 404 in FIG. 4. On the contrary, according to the present invention, with a sudden increase in the power in the core, the system according to the present invention responds with an increase in the particle energy according to curve 406 of FIG. 4.

In other words, the rise in power of the reactor is slower and, taking self-regulating effects into account, such as the Doppler effect, the final value of the power of the reactor will be lower, compared with the prior art.

Thus, controlling an ACS system by the energy of particles originating from an accelerator, this system is provided with an intrinsic safety means, adding to the other known negative feedback effects in the prior art because, in case of an uncontrolled increase in the power of the core beyond the nominal operating point (i.e., corresponding to the initial conditions), the energy of the incident particles increases sufficiently to move this operating point away from its optimal value, corresponding to the maximum yield of the conversion. Thus, the number of neutrons increases, but much less quickly than would occur in the case of an ACS system controlled by the intensity of the beam of charged particles. Consequently, the increase in power of the reactor is both slower and clearly more limited in amplitude than for the ACS systems according to the prior art.

Moreover, it is remarked that the course of both systems tends toward distinct, limited powers, i.e., a power P_{connu} for an ACS system controlled by the intensity of the particle beam, and a power Pᵢₙᵥ, such as Pᵢₙᵥ<P_{connu} for a system according to the present invention, i.e., an ACS system controlled by the energy of the particles.

As was seen with FIG. 5a, besides demonstration of a value maximizing the yield of the nuclear reactions producing neutrons, FIG. 5a shows that the present invention makes it possible to define three operating modes of the neutron source, these modes corresponding graphically to the three zones on the figure. These modes are determined by the values of the energy of the particles Eₚ, and correspond to different responses of the yield of the nuclear reactions producing neutrons with possible fluctuations in the power of the core and, consequently, to the energy Eₚ.

1—A first zone, called “dangerous,” appears for an accelerator generating particles provided with an energy from the reaction threshold energy and less than Eₚ^{Max}, which corresponds to 1.16 GeV in the example. When the particle energy is less than Eₚ^{Max}, the yield is lower, the further one moves away from Eₚ^{Max}. In addition, a slight fluctuation in the particle energy induces a very strong fluctuation in the number of neutrons produced, which makes the control of the hybrid system very delicate.

2—A second zone, called “potential instability,” is located in the vicinity of the optimum of the accelerator. The yield of the nuclear reactions producing neutrons is optimal, which optimizes the energy balance of the hybrid system. However, this mode may swing toward the “dangerous” mode. In terms of safety, a development toward the “dangerous” mode does not compromise the safety of the system because this development occurs during a drop in power produced by the reactor.

In other words, the system may become unstable in relation to the negative fluctuations of the power, which is undesirable for the control of the system.

3—A third zone, called “Doppler effect,” corresponds to a zone in which the yield of the nuclear reactions producing neutrons is very close to its optimal value, but decreases as the power required increases. This negative slope of the curve of FIG. 5a tends to limit the number of neutrons during an undesired transient, increasing this number of neutrons: One benefits more favorably from the controlling effect of the present invention, which acts in the same sense as the Doppler effect, and which is particularly advantageous when the presence of actinides reduces the influence of this Doppler effect.

To avoid the potential instability of zone 2, it is preferred to select, according to a preferred embodiment of the present invention,
Eₚ^{nom}=Eₚ^{Max}+ΔEₚ
in which the value ΔEₚ is selected so as to be greater than possible negative fluctuations in the power of the reactor in the normal operating mode of the reactor. It is this value de Eₚ^{nom}, thus selected, which marks the beginning of the third zone shown in FIG. 5a.

The present invention also pertains to an accelerator coupled hybrid nuclear system (ACS), comprising a nuclear reactor operating in subcritical mode, an external neutron source, this source comprising an accelerated beam of charged particles, the neutron source supplying the quantity of neutrons necessary in order to maintain the nuclear reaction, and means suitable for generating the electricity from the heat produced by the nuclear core, this system being characterized in that the number of neutrons induced by the accelerator is controlled by acting on the energy Eₚ of the particles, with constant beam intensity of the particles.

An example of such an embodiment is provided as a detailed disclosure of the preferred embodiment.

Preferably, the particles are protons directed in a beam at the center of the core, and the core comprises a spallation target.

This system can be controlled according to the prior art, for example, with control rods, as well as according to other possibilities with the accelerator (energy being supplied by a network).

The present invention is capable of being applied to any type of nuclear reactor, since during at least a part of its operating cycle it is able to operate in a subcritical state, rendered critical by the supply of external neutrons produced from accelerated charged particles. Thus, the reactor may be a fast neutron reactor or a thermal neutron reactor. It may also have a critical operation during the greatest part of its operation, and only have a subcritical operation, as described above, temporarily or occasionally.

In fact, the present invention applies to any type of subcritical nuclear reactor fed by means of an external source having an optimal yield value in its neutron production and using a particle accelerator making it possible to control the particle energy.

To use the present invention in an accelerator coupled hybrid nuclear system, two conditions are required only: On the one hand, that the nuclear reactions producing the neutrons be carried out according to a global curve having a maximum yield value, as it is especially the case for spallation and photonuclear reactions considered globally; and, on the other hand, that the accelerator used be able, either directly or indirectly, to be controlled by particle energy with a constant beam intensity. Any reactor core to which an external neutron source is joined, even though temporarily, is to be considered to be a hybrid nuclear system.

Other features and advantages of the present invention shall become evident with the description provided below in an illustrative and nonlimiting manner, making reference to the attached figures, in which:

FIGS. 1a and 1b, already described, are functional diagrams of hybrid nuclear systems,

FIG. 2, already described, is a diagram representing the relationships between the intensity of the spallation neutron source and the power of the core of a nuclear reactor for different hybrid systems,

FIG. 3a is a diagram 300 representing, according to the Y axis 302, the variation of the current of particles emitted by an accelerator depending on the energy Eₚ (X axis 304) of these particles, this FIG. 3a thus being a diagram related to the current Iₚ of particles produced by an accelerator depending on the energy of these particles for a given value of the power consumed by the accelerator,

FIG. 3b is a diagram related to the neutron production yield for different combinations of the energy of the particles generating these neutrons and beam intensity, these combinations being defined with a fixed power consumed by the accelerator,

FIG. 4 is a diagram comparing the increase in power of an accelerator coupled nuclear system according to the prior art with a system according to the present invention,

FIGS. 5a and 5b are diagrams representing the number of external neutrons produced normed by the energy having been used to produce them (Y axis), depending on the energy of the incident particles (X axis), an application of two embodiments of the present invention: with spallation reactions for FIG. 5a, and with photonuclear reactions for FIG. 5b,

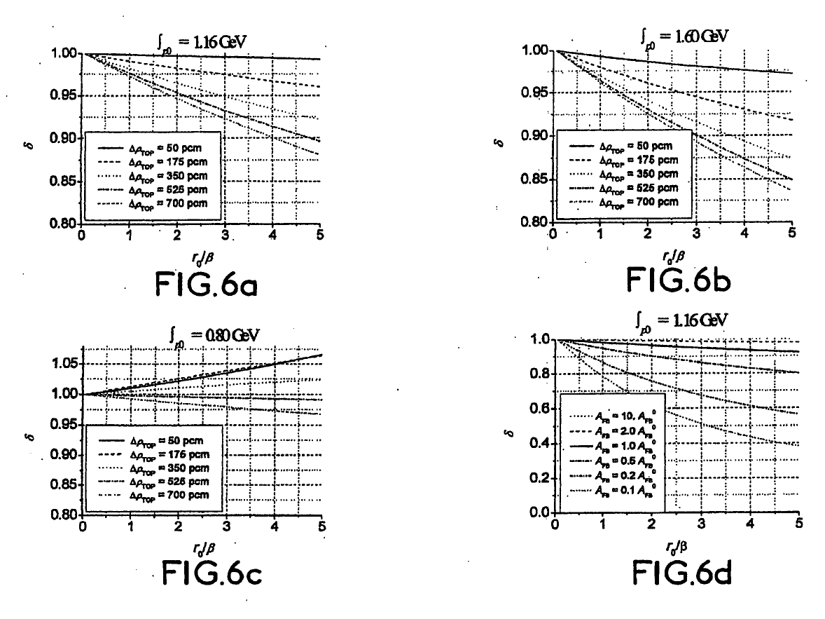

FIGS. 6a, 6b, 6c and 6d are diagrams showing the effectiveness of a method according to the present invention.

### DETAILED DESCRIPTION OF THE PREFERRED EMBODIMENT

### A Hybrid System with Molten Salt with Spallation Source

In this embodiment example of the present invention, an accelerator coupled system ACS is provided with a molten salt core (with fast spectrum with a Thorium-based circulating fuel). It is assumed that the yield of the accelerator ηₐ does not depend on the energy Eₚ. According to this condition, the energy of the charged particles is proportional to the power produced. It being given that the latter is proportional to the power consumed by the accelerator and by normalizing in relation to the nominal power, the energy of the incident particles is obtained:
Eₚ=Eₚ^{nom}P_{cons}/P_{cons}^{nom}. (10)

For a Thorium-based fuel, the probability of fission of the main fissile isotope, uranium 233, depends little on the energy of the neutrons, the neutron importance may be considered constant and equal to 1: φ*=1.

The power of the core P_{c} in a new state of equilibrium (after insertion of reactivity Δρ_{TOP}) can be found from the expression:
(Δρ_{TOP}+Δρ_{FB}−r₀)P_{c}+r₀P_{cons}^{nom}Y(Eₚ)/Y(Eₚ^{nom})=0 (11)
The negative feedback effects in the core are described by a linear model:
Δρ_{FB}=A_{FB}βP_{c}
in which A_{FB} is the negative feedback factor.

It shall be considered that a spallation reaction by high-energy protons (˜1 GeV) is used for the production of neutrons. The yield of the neutrons by an incident proton in a lead target (with the dimensions: diameter D=20 cm and length L=60 cm, particle energy Eₚ ranging from 0.8 GeV to 8 GeV) can be expressed by the empirical formula, presented in the document of Pankratov et al. “Secondary Neutron Yields from Thick Pb and W Targets Irradiated by Protons with Energy 0.8 and 1.6 GeV,” Proceedings of the Second International Conference on Accelerator-Driven Transmutation Technologies and Applications, Kalmar, Sweden, V2 (1996), pp. 694-697:
Yₙ(Eₚ)=−a+bEₚ^{3/4},
in which Eₚ is measured in GeV and the empirical parameters a and b are: a=8.2; b=29.3.

As is seen in FIG. 5a, the production of neutrons is optimal for an energy equal to: Eₚ=(4a/b)^{4/3}=1.16 GeV. If this energy is selected as the nominal proton energy, in case of an increase in the power of the core, the external source will no longer succeed in creating a sufficient quantity of neutrons to support the critical state of neutron balance in the hybrid system (fission neutrons plus external neutrons). It can be said that the system (it may be called DENNY or Delayed Enhanced Neutronics with Non-linear neutron Yield) has a novel “Doppler” negative feedback effect for the accelerator part (“Yₙ effect”), which may also be used for the improvement of safety.

To illustrate the magnitude of the “Yₙ effect,” two systems are compared as an example: on the one hand, an ACS with the linear dependence (according to the prior art) between the intensity of the source, and on the other hand, a “DENNY” (according to the present invention). To describe the effectiveness of the “Y effect,” the parameter δ=p^{DENNY}/P^{ACS} is introduced, which is the ratio of the asymptotic powers of the DENNY and of the ACS (DEN) after having introduced the same value of the reactivity Δβ_{TOP}. The fact that δ<1 means that the asymptotic power in the DENNY is not as great as that of the ACS system.

The calculation results of δ as a function of the parameters r₀ and Δρ_{TOP} are presented in FIGS. 6a through 6d. Three nominal energy values have been chosen: Eₚ^{nom}=1.16 GeV (a), Eₚ^{nom}=1.60 GeV (b) and Eₚ^{nom}=0.80 GeV (c). The comparison of these results makes it possible to draw the following conclusions:
the “Yₙ effect” increases when r₀ and Δρ_{TOP} increase. This effect may be significant: up to 10% or 15% for r₀=5β. The increase in Δρ_{TOP} leads to the saturation of this tendency;
the “Yₙ effect” becomes greater if the nominal energy of the protons is increased beyond the optimal energy;
in the example studied, the optimal energy value of the particles Eₚ^{Max}=1.16 GeV is very suitable for transients of relatively low amplitude, which is linked with the nonlinear dependence.

The relative effectiveness of the “Yₙ effect” as regards the Doppler effect depends a lot on the thermohydraulic parameters of the hybrid system. The dependence of δ on the parameter A_{FB}, which describes the negative feedback effects as well as the thermohydraulic properties of the system, can be examined to estimate the influence of these parameters. The calculation result, shown in FIG. 6d, shows that the effect of a reduction in the excursion of the lower is less significant if the parameter A_{FB} increases.

1-12. (canceled)

13. Method of controlling an accelerator coupled nuclear system (ACS) comprising a nuclear reactor, having a core, the nuclear reactor, operating in subcritical mode, and a neutron generator device using a beam of accelerated charged particles, the neutron generator consuming a predetermined amount of energy f^{nom} produced by the core in order to produce a number of external neutrons for maintaining a nuclear chain reaction in the core, and an operating point of the system being selected at a nominal charged particle energy Eₚ^{nom} close to an optimal energy value Eₚ^{nom} for which a relationship between the number of external neutrons produced and an energy of a beam of the charged particles used by the neutron generator device to produce the neutrons is maximum, the method comprising the steps of, for a self-regulated and reliable operation of the coupled system selecting the nominal particle energy Eₚ^{nom} to be greater than the optimal energy value Eₚ^{max}, and adjusting the number of external neutrons depending on operating power fluctuations of the nuclear reactor by acting on the energy of the charged particles (Ep) generated and accelerated by the accelerator.

14. Method of controlling an accelerator coupled nuclear system (ACS) in accordance with claim 13, wherein the operating point of the system is determined by the nominal particle energy Eₚ^{nom} being equal to a sum of the optimal energy Eₚ^{max} and an energy ΔEₚ selected so as to be greater than possible negative fluctuations of the charged particle energy in response to the negative fluctuations of the power of the reactor in the normal operating mode of the reactor.

15. Method of controlling an accelerator coupled nuclear system (ACS) in accordance with claim 13, characterized in that it comprises the following steps:
1. determining operating conditions under which the nuclear reactor is to be operated including: level of subcriticality (r₀), consumable power to be produced, thermal power Pₜₕ or electric power Pₑₗ=ηₑₗPₜₕ where ηₑₗ is the electric yield of the plant, quantity and kind of fuel,
2. from the determined operating conditions, determining operating parameters of the accelerator as follows:
a—determining the optimal energy Eₚ^{Max} of the charged particles, which verifies the expression:
d/dEₚ[φ*(Eₚ)ηₐ(Eₚ)Y(Eₚ)/Eₚ]=0. (1)
in which Eₚ is the energy of the charged particles, Yₙ is the neutron yield, φ* is the neutron importance, and ηₐ is the yield of the accelerator,
b—selecting the nominal energy Eₚ^{nom} to be equal to or greater than the optimal energy Eₚ^{Max}:
Eₚ^{nom}=Eₚ^{Max}+ΔEₚ, ΔEₚ≧0. (2)
c—determining a nominal intensity Iₚ^{nom} of the beam of charged particles necessary to obtain a nominal power of the reactor Pₜₕ^{nom} depending on a nominal energy Eₚ^{nom}, on the neutron yield Yₙ(Eₚ^{nom}), on the yield of the accelerator ηₐ(Eₚ^{nom}), on the average number v of fission neutrons, on the energy E_{fis} supplied in a fission reaction, and on the neutron importance φ*(Eₚ^{nom}) for the nominal energy Eₚ^{nom} according to the equation:
Iₚ^{nom}=r₀vPₜₕ^{nom}/[E_{fis}φ*(Eₚ^{nom})Yₙ(Eₚ^{nom})], (3)
as well as the amount of energy produced by the reactor that is consumed by the accelerator according to the equation:
f^{nom}=Eₚ^{nom}r₀v/[E_{fis}φ*(Eₚ^{nom})Y(Eₚ^{nom})ηₐ(Eₚ^{nom})ηₑₗ. (4)
3. setting the amount of energy produced by the reactor that can be consumed by the accelerator as a fraction f of the total energy produced by the reactor, as well as the intensity of the charged particle beam at nominal values according to the following formulas:
Iₚ^{nom}=r₀vPₜₕ^{nom}/[E_{fis}φ*(Eₚ^{nom})Yₙ(Eₚ^{nom})], (3)
f^{nom}=Eₚ^{nom}r₀v/[E_{fis}φ*(Eₚ^{nom})Yₙ(Eₚ^{nom})ηₐ(Eₚ^{nom})ηₑₗ. (4)
4. adjusting the number of external neutrons acting on the particle energy Eₚ with constant beam intensity, depending on the operating power fluctuations of the nuclear reactor, according to an expression that defines the fluctuation of the energy:
Eₚ=f^{nom}Pₑₗηₐ(Eₚ)/Iₚ^{nom} (5)

16. Method of controlling an accelerator coupled nuclear system in accordance with any of the above claims, in which the charged particles are protons, and the neutron-generating nuclear reaction is a spallation reaction.

17. Method of controlling an accelerator coupled nuclear system in accordance with claim 16, in which the spallation target is made of lead-bismuth, and the optimal proton energy Eₚ^{Max} ranges from 0.5 GeV to 2.5 GeV.

18. Method of controlling an accelerator coupled nuclear system in accordance with any of the claims 13 through 15, in which the charged particles are electrons, and the neutron-generating nuclear reaction is a photonuclear reaction.

19. Accelerator coupled nuclear system comprising a nuclear reactor, having a core, operating In subcritical mode and a neutron generator device using a beam of accelerated charged particles, the neutron generator consuming a predetermined amount of energy f^{nom} produced by the core in order to produce a number of external neutrons for maintaining a nuclear chain reaction in the core, and an operating point of the system being selected at a particle energy value Eₚ^{nom} close to an optimal energy value Eₚ^{max} for which a relationship between the number of external neutrons produced and an energy of the charged particle beam used to produce the neutrons is maximum, the system comprising, for a self-regulated and reliable operation, it comprises means for selecting the nominal particle energy Eₚ^{nom} to be greater than the optimal energy value Eₚ^{max}, and, adjusting the number of external neutrons depending on operating power fluctuations of the nuclear reactor by acting on the energy of the charged particles (Ep) generated and accelerated by the accelerator.

20. System in accordance with claim 19, further comprising means for determining the operating point of this system by a nominal particle energy Eₚ^{nom} equal to a sum of the optimal energy Eₚ^{max} and an energy ΔEₚ selected so as to be much greater than possible negative fluctuations of the charged particle energy in response to the negative fluctuations of the power of the reactor in the normal operating mode of the reactor.

21. Accelerator coupled nuclear system in accordance with claim 19 or 20, wherein the charged particles are protons directed in a beam at a central part of the core, and the core comprises a spallation target.

22. Accelerator coupled nuclear system in accordance with claim 21, in which the spallation target is surrounded by a buffer, having a conversion yield that is less than half of a conversion yield of the spallation target.

23. Accelerator coupled nuclear system in accordance with claim 19 or 20, comprising a target for producing the neutrons in response to the charged particles, the target having an optimized geometry which increases losses of the charged particles in this target.
